(19) United States
(12) Patent Application Publication
(10) Pub. No.: US 2011/0218819 A1
(43) Pub. Date: Sep. 8, 2011

(54) METHOD, APPARATUS AND COMPUTER PROGRAM PRODUCT FOR PROVIDING A DISTRIBUTED CARE PLANNING TOOL

(75) Inventor: Arien Malec, Oakland, CA (US)

(73) Assignee: McKesson Financial Holdings Limited

(21) Appl. No.: 12/715,633

(22) Filed: Mar. 2, 2010

(51) Int. Cl. G06Q 50/00; G06Q 10/00; G06F 3/048

(52) U.S. Cl. 705/3; 705/2; 715/771

(57) ABSTRACT

A method for providing distributed care plan management may include receiving, at a service platform, information associated with a care plan item for a patient in which the information is received from a health system entity among a plurality of health system entities with which the service platform is capable of communicating. The method may further include storing the information in association with a care plan of the patient, and providing delivery of at least a portion of the information to a different entity with selected view parameters for rendering the portion of the information being determined based on an identity of the different entity. A corresponding computer program product and apparatus are also provided.

### TECHNOLOGICAL FIELD

Embodiments of the present invention relate generally to healthcare management solutions and, more particularly, relate to a mechanism by which care planning activities may be managed across a plurality of separate healthcare related entities.

### BACKGROUND

For many years, the mechanism for evaluating clinical processes related to a particular patient has been the medical chart or medical record. As such, for example, the medical record has been used to record patient identification, health history, medical examination and/or lab test results, medical prescriptions and other information such as, for example, orders related to the particular treatments or diagnoses associated with the patient. Accordingly, in order to assess whether a patient has received or is due to receive a particular treatment or care related event, the patient's chart would typically be reviewed. Additionally, in order to become aware of the results of various tests or treatments or to keep abreast of trends in certain indicators related to a particular condition or treatment, chart review would typically be required.

Recently, efforts have been made to move to electronic medical records (EMR). Although the EMR concept has encountered many issues in relation to, for example, cost, security, interoperability, etc., many hospitals are either employing, or planning to employ, some form of EMR. With clinical documentation systems moving to electronic media, clinical data may be available for incorporation into a number of different applications designed to assist in the management or use of such data. Computerized provider order entry (CPOE) is one example of a development that may improve the ability to electronically access information related to physician's orders. Many other applications are being developed to utilize electronic information on people and processes to manage the provision of various aspects of patient care including the provision of predictive care.

As the availability of electronic clinical data is increasing, the demand for applications that utilize such data to provide information, guidance and services is also increasing. Many applications have been developed to assist hospitals, clinics, doctors, insurance companies, and other healthcare related service providers with various aspects of improving patient care. However, since each healthcare related entity may employ its own judgment with respect to the applications it can afford or otherwise desires to utilize, a wide variety of applications with differing mechanisms for identifying patients and for tracking care related activities associated with managing a care plan for each respective patient may be employed even a single healthcare related entity, much less over a cross section of different healthcare related entities.

As such, because patients often see different healthcare related entities, even potentially in relation to a single health problem, it may be extremely difficult to reconcile care plan management for patients among the different healthcare related entities. Accordingly, it may be desirable to provide an improved mechanism by which care plan management is conducted within a healthcare system, and across multiple healthcare systems.

### BRIEF SUMMARY

A method, apparatus and computer program product are therefore provided to enable the provision of a distributed care plan management system. Such a system may be used to enable the provision of multi-disciplinary collaborative medicine for healthcare systems nationwide. Accordingly, the quality of patient care may be increased and the ability to provide various different healthcare related entities with information that is tailored to their own respective needs using a single information store may be increased.

In one exemplary embodiment, a method for providing distributed care planning is provided. The method includes receiving, at a service platform, information associated with a care plan item for a patient in which the information is received from a health system entity among a plurality of health system entities with which the service platform is capable of communicating. The method may further include storing the information in association with a care plan of the patient, and providing delivery of at least a portion of the information to a different entity with selected view parameters for rendering the portion of the information being determined based on an identity of the different entity.

In another exemplary embodiment, a computer program product for providing distributed care planning is provided. The computer program product may include at least one computer-readable storage medium having computer-executable program code instructions stored therein. The computer-executable program code instructions may include program code instructions for receiving, at a service platform, information associated with a care plan item for a patient in which the information is received from a health system entity among a plurality of health system entities with which the service platform is capable of communicating. The program code instructions may further be for storing the information in association with a care plan of the patient, and providing delivery of at least a portion of the information to a different entity with selected view parameters for rendering the portion of the information being determined based on an identity of the different entity.

In another exemplary embodiment, an apparatus for providing distributed care planning is provided. The apparatus may include processing circuitry. The processing circuitry may be configured for receiving, at a service platform, information associated with a care plan item for a patient in which the information is received from a health system entity among a plurality of health system entities with which the service platform is capable of communicating. The processing circuitry may further be configured for storing the information in association with a care plan of the patient, and providing delivery of at least a portion of the information to a different entity with selected view parameters for rendering the portion of the information being determined based on an identity of the different entity.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing distributed care planning according to an exemplary embodiment of the present invention;

FIG. 2 is a block diagram showing various components that may be included in an apparatus for providing distributed care planning according to an exemplary embodiment of the present invention; and

FIG. 3 is a block diagram according to an exemplary method for providing distributed care planning according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which a care plan model may be provided (e.g., in electronic form) that may enable access to the care plan by a plurality of different entities. Furthermore, the care plan model may be designed to interact with each respective entity in a manner that corresponds to access rights and presentation paradigms that are appropriate for each respective entity. Thus, for example, the various different entities may all be enabled to interact with the care plan model to provide information thereto and receive information therefrom as appropriate. However, the interface for each different entity may also, in some cases, be tailored to the access rights, needs or capabilities of the corresponding different entities. Thus, a plurality of entities may be enabled to interact with a single information source to update or review care plan related information to provide distributed care management functionality. Accordingly, not only can different health system entities coordinate care plan related activities so that events or activities associated with a particular patient may be coordinated between the health system entities such that information associated with orders, lab or test results, billing and other services may be more easily exchanged between health system entities, but health care providers, insurance providers, patients and/or others with an interest in care plan management may be enabled to receive information of specific interest to them via a relatively filtered or focused delivery tool using a corresponding one of a plurality of specific views of the information that may be available. Embodiments of the present invention may provide a central repository for information, but may also be interoperable with other proprietary systems to enable receipt of information from other systems and the provision of information to other systems.

As an example, a patient entering a particular health system entity (e.g., a hospital) in association with a particular ailment may be registered for any events that are to be conducted for treatment and/or follow-up care. The events may be entered as a part of a care plan associated with the particular patient. More specifically, the events may be associated with a care plan item for the particular ailment. The care plan item (and perhaps other care plan items for other ailments) may include a clinical outcome (or goal) as well as any actions, completion dates, responsible parties and/or the like, associated with the care plan item. The care plan may then be accessible to all parties associated with the events associated with the care plan in such a manner as to permit access to orders or action items and/or to record results applicable to the orders or action items. Access may also be granted to the patient and/or various care providers (e.g., the responsible parties) to review status information. Moreover, each party's access may be provided by a view that is tailored to the corresponding party. Accordingly, embodiments of the present invention may enable different health system entities and other parties interested in a care plan to coordinate care plan management using a central interoperable platform.

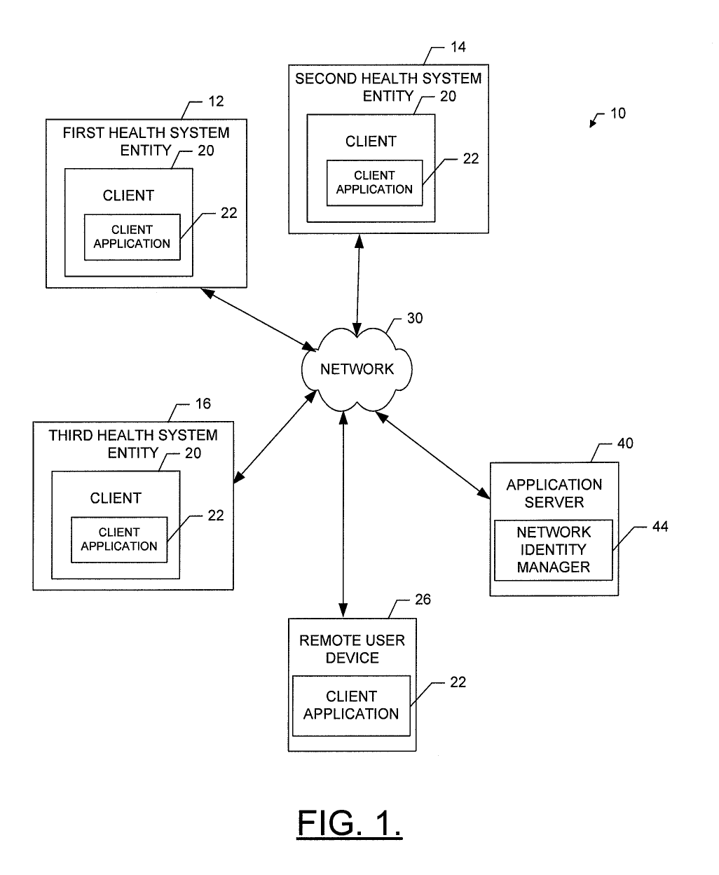

An exemplary embodiment of the invention will now be described in reference to FIG. 1, which illustrates an exemplary system in which an embodiment of the present invention may be employed. As shown in FIG. 1, a system according to an exemplary embodiment may include a plurality of health system entities forming a global health system network 10. Although FIG. 1 illustrates the global health system 10 as including three health system entities (e.g., a first health system entity 12, a second health system entity 14 and a third health system entity 16), it should be noted that the global health system may include more or less health system entities in alternative embodiments. The health system entities may be in communication (or at least capable of communication) with each other via a network 30. In some embodiments, a remote user device 26 (e.g., a computer or access terminal of a patient) may also be used to access the network 30.

In an exemplary embodiment, the health system entities may each correspond to one or more of healthcare systems, hospitals, imaging centers, laboratories, healthcare provider offices, research institutions, provider homes, insurance companies, data centers, clinics, and/or the like. Accordingly, in some cases, the health system entities may include, for example, a healthcare system, an imaging center, and/or a healthcare provider office that are all within the same geographic area. However, in other cases, the health system entities could be healthcare systems in different geographic areas. Thus, the global health system 10 may represent any scalable network of health system entities nationwide.

Each health system entity may include or otherwise be associated with one or more clients 20 that may, in some cases, be associated with managing patient care plans as they relate to inputs from each health system entity and outputs to each health system entity and perhaps also to patients. As such, for example, one client 20 may be associated with the first health system entity 12 (e.g., a local hospital) and a second client 20 may be associated with the second health system entity 14 (e.g., a local imaging center). Each client 20 may be, for example, a computer (e.g., a personal computer, laptop computer, network access terminal, or the like) or may be another form of computing device (e.g., a personal digital assistant (PDA), cellular phone, or the like) capable of communication with a network 30.

As such, for example, each client 20 (and the remote user device 26) may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an exemplary embodiment, one or more of the clients 20 (and the remote user device 26) may include a client application 22 configured to enable one or more of various functions including, for example, data entry, information consumption, application execution, and/or the like. In this regard, for example, the client application 22 may include software for enabling a respective one of the clients 20 (and/or the remote user device 26) to communicate with the network 30 for the provision of and receipt of information associated with various aspects of providing patient care. Thus, for example, the client application 22 may include corresponding executable instructions for configuring the client 20 (and/or the remote user device 26) to provide corresponding functionalities for the provision of and receipt of information associated with a care plan such as receiving patient care data, processing patient care data and/or providing patient care data as described in greater detail below. Moreover, in an exemplary embodiment, the client application 22 may include functionality, either alone or in cooperation with other applications and/or processing devices, for providing and/or requesting information associated with actions, orders, requests, events, responsible parties, treatment goals, timing requirements and/or the like throughout the global health system network 10. As such, in some examples, the client application 22 may include functionality associated with provision of a patient care plan management software suite that may also include or be in communication with an identity resolver used to correlate entities between different systems.

The network 30 may be a data network, such as a local area network (LAN), a metropolitan area network (MAN), a wide area network (WAN) (e.g., the Internet), and/or the like, which may couple the clients 20 (and/or the remote user device 26) to devices such as processing elements (e.g., personal computers, server computers or the like) or databases. Communication between the network 30, the clients 20, the remote user device 26 and the devices or databases (e.g., servers) to which the clients 20 and the remote user device 26 are coupled may be accomplished by either wireline or wireless communication mechanisms and corresponding protocols.

In an exemplary embodiment, one of the devices to which the clients 20 and the remote user device 26 may be coupled via the network 30 may include one or more application servers (e.g., application server 40), which may in some cases form respective elements of a server network. Although the application server 40 is referred to as a “server”, this does not necessarily imply that the application server is embodied a single device or that the device is necessarily a server running a server operating system. As such, for example, the application server 40 may be embodied in a distributed fashion in some instances. Furthermore, the application server 40 could simply be a computer, such as a personal computer or laptop, which is configured to act in a server role with respect to providing services and information to the clients 20 and the remote user device 26.

The application server 40 may include hardware and/or software for configuring the application server 40 to perform various functions. As such, for example, the application server 40 may form a service platform including respective processing logic and memory enabling the application server 40 to access and/or execute stored computer readable instructions for performing various functions. In an exemplary embodiment, one function that may be provided by the application server 40 may be the provision of network identity management to enable certain patient related information to be provided to or shared between the clients 20 and perhaps also the remote user device 26. In this regard, for example, the application server 40 may include or otherwise be in communication with a care plan manager 44 configured to provide a central care plan that may interact with a plurality of different systems to receive care plan related information and may also be configurable to provide different views for corresponding various different information consumers. As such, data provided to the care plan manager 44 may essentially be coordinated amongst the health system identities of the global health system network 10 to enable access and manipulation to the coordinated information by the clients 20 (and the remote user device 26) as needed or otherwise desired.

Additionally or alternatively, the application server 40 may be configured to enable the clients 20 to provide information to the application server 40, for use by the application server 40 in producing, maintaining and/or supplying care plan related information among other types of data. In this regard, for example, the application server 40 (or servers) may include particular applications related to various different information management modules including modules such as electronic medical record modules, billing or accounting modules, a care plan management module (e.g., via the care plan manager 44) and other healthcare related applications. As such, some application servers and clients may host data entry mechanisms that enable the entry of patient information, treatment information, test results, medical history, orders, medications, observations, and numerous other types of information that may be related to a particular care plan item. The care plan manager 44 may thereafter provide a central location for storage of information related to care plan items and provide access to external devices requesting access to some portion of the care plan items, but further provide such access in a manner that is tailored specifically to the requester.

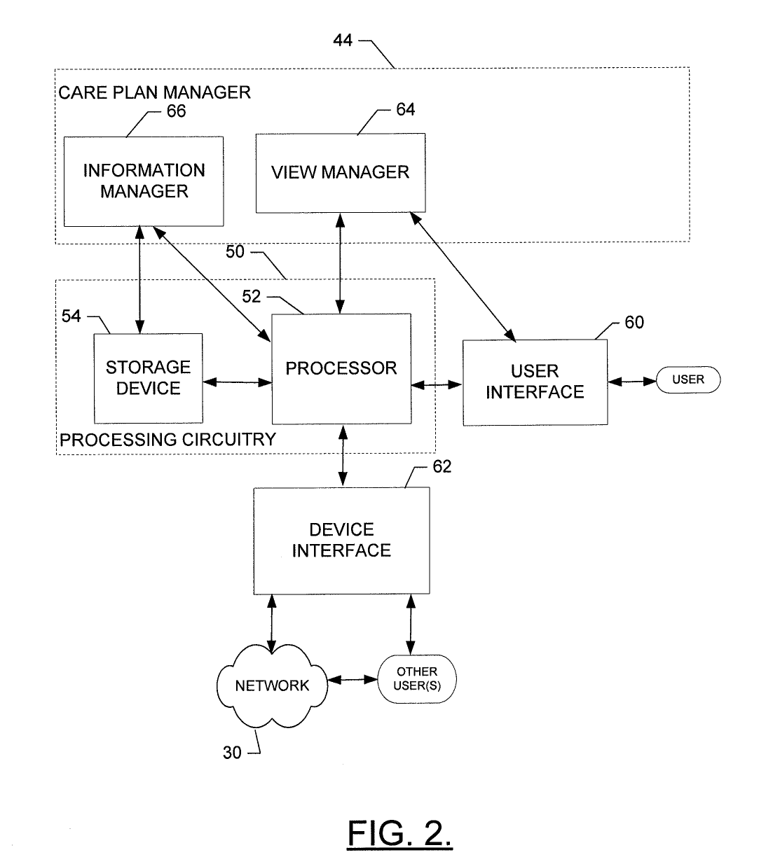

As indicated above, the care plan manager 44 may provide functionality for coordination of care plan item management within the network 30 to provide that information associated with care plan items pertaining to a particular patient at one health system entity can be made available to another health system entity or perhaps to the patient. In some cases, the care plan manager 44 may present information via pages of a web application to respective entities or may expose an interoperable system with software applications that are interactive with other systems. An exemplary embodiment of the invention will now be described with reference to FIG. 2. FIG. 2 shows certain elements of an apparatus for providing a distributed care planning tool according to an exemplary embodiment. The apparatus of FIG. 2 may be employed, for example, on a variety of devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients 20 or the remote user device 26). Furthermore, it should be noted that the devices or elements described below may not be mandatory and thus some may be omitted in certain embodiments.

Referring now to FIG. 2, an apparatus for providing a distributed care planning tool is illustrated by way of example. The apparatus may include or otherwise be in communication with processing circuitry 50 that is configured to perform data processing, application execution and other processing and management services according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. However, in some cases where the apparatus is embodied at a server or other network device, the user interface 60 may be limited, remotely located, or even eliminated.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an exemplary embodiment, the storage device 54 may include one or more memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., a database associated with information manager 66) that may store a variety of files, contents or data sets. Among the contents of the storage device 54, applications may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control the care plan manager 44, which may include, be in communication with, or in some cases control a view manager 64, an information manager 66 and a interactivity manager 68. The example of FIG. 2 shows the view manager 64, the information manager 66 and the interactivity manager 68 each being a portion of the care plan manager 44. However, in some cases, one or more of the view manager 64, the information manager 66 and the interactivity manager 68 may be separate devices from the care plan manager 44 that are controlled by the care plan manager 44.

The view manager 64, the information manager 66 and the interactivity manager 68 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the view manager 64, the information manager 66 and the interactivity manager 68, respectively, as described below.

The view manager 64 may be configured to provide different views to corresponding different entities. In some cases, the different views provided may be generated based on access restrictions associated with the data being requested and/or the credentials of the requesting party. In other cases, different views may be provided based merely on the identity of the requester in light of the information requested. For example, if the patient is requesting information, the patient may have access to all portions of the care plan, but may be offered views of the information via a patient interface that is generated to provide information that is typically most requested by patients and provides the information in a format that is user friendly and easy to understand for the average patient. Meanwhile, if a particular health system entity (e.g., a lab) is requesting information, the view generated may be a view that offers access to only information for which orders or other specific events or activities indicate responsibility on the part of the corresponding particular health system entity. Thus, for example, the lab may only be enabled to view orders for lab work and/or other information associated with assistance the lab may be involved with relative to a particular care plan item.

In an example embodiment, the view manager 64 may be configured to provide pre-determined view templates for respective ones of each of various different entities. For example, a view template may exist for providing patient centered data viewing, doctor centered data viewing, case manager centered data viewing, and/or the like. Each view may be offered simultaneously to corresponding different entities using the same basic information (or at least some of the same basic information) while presenting the information via corresponding unique views in a distributed fashion. Thus, for example, numerous different entities can each receive a feed of information in a personalized fashion. In an example embodiment, rather than employing a template for defining views to be presented to each respective different entity, the view manager 64 may include an algorithm that selects views and/or data items and their corresponding locations and presentation parameters based on an identity of the entity that is to receive the data. The data and presentation parameters selected by the view manager 64 may then be pushed out to the corresponding entity in the selected format.

The information manager 66 may be configured to store information and respond to requests for information. As such, for example, the information manager 66 may include a portion of or otherwise be in communication with the storage device 54 to enable storage of information received in connection with a particular care plan item to be stored in association with the corresponding care plan item. The information manager 66 may be capable of storing care plans for a plurality of patients and, for each respective patient, may also be enabled to store a plurality of care plans items. Accordingly, the information manager 66 may be enabled to receive information submitted thereto and store the received information in association with a corresponding care plan and/or care plan item.

When requests are received, the information manager 66 may be enabled to determine access rights for the requester, if applicable, and generate a response to the request. The response to the request may include information that may be passed to the view manager 64 in order to enable the view manager 64 to provide the information requested to the requester in an appropriate format. In some embodiments, the information manager 66 may include one or more different context modules corresponding to each of various different contexts that may exist for data to be stored. For example, the information manager 66 may include an orders context for dealing with information associated with orders. Numerous other contexts may also be included (e.g., prescriptions or other care related events and/or actions).

In an example embodiment, as indicated above, each care plan item may include a corresponding goal or outcome that is defined (e.g., by a case manager) for the corresponding care plan item. Various actions or orders that have been defined or prescribed to facilitate achievement of the goal may also be stored in association with each care plan item. Each care plan item may also include information defining the completion dates assigned for each goal and/or the parties responsible for completion of various tasks. Accordingly, when a particular view is tailored to a corresponding entity, at least in some instances, the tailored view may be generated based on the responsibilities of a particular party relative to the care plan items associated with a particular patient. The care plan items themselves may be defined for respective different chronic illnesses as well as acute conditions for which a care plan is drafted.

The interactivity manager 68 may be configured to manage interactions of the care plan manager 44 with various other health system entities. In this regard, the interactivity manager 68 may be configured to enable the care plan manager 44 to interact with an electronic medical record or electronic medical record tools to receive information associated with the electronic medical record (e.g., reported to an electronic medical record tool) and extract the information that is pertinent to a care plan or particular care plan items of the care plan. Moreover, the interactivity manager 68 may include translators and/or interpreting mechanisms to enable the care plan manager 44 to receive information from and provide information to various different proprietary systems. As such, the interactivity manager 68 may enable the care plan manager 44 to give instructions to other systems and receive reports from other systems. As an example, if a clinical order is issued by the first health system entity 12 to order a HbA1c draw due to poorly managed diabetes, the interactivity manager 68 may interact with the client of the first health system entity 12 to provide the order in connection with the corresponding care plan for diabetes for the patient. If the second health system entity 14 is defined as the responsible party for performing the draw, the second health system entity 14 may be informed and/or may be enabled to retrieve the order from the care plan manager 44 via the interactivity manager 68. After conducting the draw, the results may be provided to update the corresponding care plan item and the first health system entity 12 may be informed of completion of the task assigned. The first health system entity 12 may then be enabled to receive a tailored view of the updated care plan. A case manager at a third health system entity 16 managing the care plan may be enabled to follow progress as indicated by the care plan manager 44 via the interactivity manager 68. In some cases, the remote user device 26 may also be used to enable the patient to access information associated with the patient's care plan via the interactivity manager 68.

Some embodiments may therefore provide a networked, multi-disciplinary care plan management tool that may be interoperable with a plurality of external systems. Accordingly, various different entities may be enabled to access information associated with a care plan to create a central repository for care plan information that can be accessed by various different entities with configurable views that are generated based on the identity of the entities accessing the data.

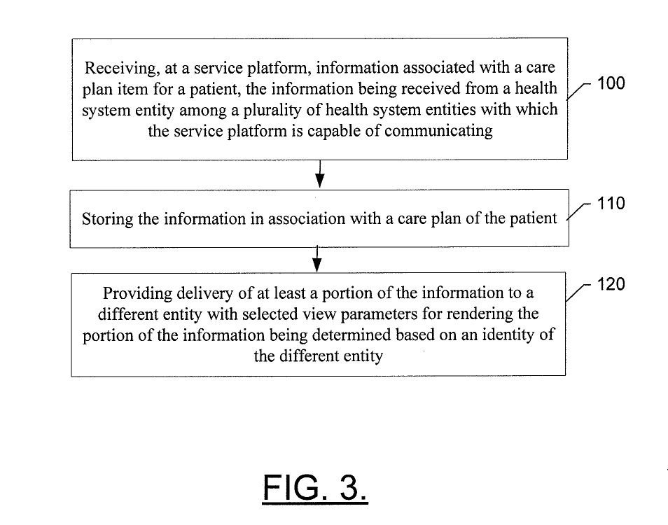

Embodiments of the present invention may therefore be practiced using an apparatus such as the one depicted in FIG. 2. However, other embodiments may be practiced in connection with a computer program product for performing embodiments of the present invention. FIG. 3 is a flowchart of a method and program product according to exemplary embodiments of the invention. Each block of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a non-transitory storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide steps for implementing the functions specified in the flowchart block(s).

In this regard, a method according to one embodiment of the invention, as shown in FIG. 3, may include receiving, at a service platform, information associated with a care plan item for a patient in which the information is received from a health system entity among a plurality of health system entities with which the service platform is capable of communicating at operation 100. The method may further include storing the information in association with a care plan of the patient at operation 110, and providing delivery of at least a portion of the information to a different entity with selected view parameters for rendering the portion of the information being determined based on an identity of the different entity at operation 120.

In some embodiments, various ones of the operations described above may be modified. The modifications may generally occur in any combination and in any order. In this regard, for example, receiving the information may further include receiving additional information from multiple respective ones of the plurality of health system entities or receiving patient specific and care plan item specific information for a plurality of different patients. In some cases, storing the information may include storing the additional information received from each of the multiple respective ones of the plurality of health system entities in association with a corresponding care plan item of the care plan or storing the patient specific and care plan item specific information received in association with a corresponding care plan item of each respective different patient. In an example embodiment, providing delivery of the portion of the information may include providing a different view of different selected information for respective ones of a patient, a care provider or a care manager. In some cases, providing the different view may include utilizing a view selection algorithm to select view parameters based on the identity. In some embodiments, providing the different view may include utilizing a view template to provide a view of the selected information based on the identity. In an exampled embodiment, receiving the information may include receiving the information from health care entities employing different applications for generation of the information.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing distributed care plan management comprising:
receiving, at a service platform, information associated with a care plan item for a patient, the information being received from a health system entity among a plurality of health system entities with which the service platform is capable of communicating;
storing the information in association with a care plan of the patient; and
providing, via processing circuitry, delivery of at least a portion of the information to a different entity with selected view parameters for rendering the portion of the information being determined based on an identity of the different entity.

2. The method of claim 1, wherein receiving the information further comprises receiving additional information from multiple respective ones of the plurality of health system entities and wherein storing the information comprises storing the additional information received from each of the multiple respective ones of the plurality of health system entities in association with a corresponding care plan item of the care plan.

3. The method of claim 1, wherein receiving the information further comprises receiving patient specific and care plan item specific information for a plurality of different patients and wherein storing the information comprises storing the patient specific and care plan item specific information received in association with a corresponding care plan item of each respective different patient.

4. The method of claim 1, wherein providing delivery of the portion of the information comprises providing a different view of different selected information for respective ones of a patient, a care provider or a care manager.

5. The method of claim 4, wherein providing the different view comprises utilizing a view selection algorithm to select view parameters based on the identity.

6. The method of claim 4, wherein providing the different view comprises utilizing a view template to provide a view of the selected information based on the identity.

7. The method of claim 1, wherein receiving the information comprises receiving the information from health care entities employing different applications for generation of the information.

8. A computer program product for providing distributed care plan management, the computer program product comprising at least one computer-readable storage medium having computer-executable program code instructions stored therein, the computer-executable program code instructions comprising:
program code instructions for receiving, at a service platform, information associated with a care plan item for a patient, the information being received from a health system entity among a plurality of health system entities with which the service platform is capable of communicating;
program code instructions for storing the information in association with a care plan of the patient; and
program code instructions for providing delivery of at least a portion of the information to a different entity with selected view parameters for rendering the portion of the information being determined based on an identity of the different entity.

9. The computer program product of claim 8, wherein program code instructions for receiving the information further include instructions for receiving additional information from multiple respective ones of the plurality of health system entities and wherein program code instructions for storing the information include instructions for storing the additional information received from each of the multiple respective ones of the plurality of health system entities in association with a corresponding care plan item of the care plan.

10. The computer program product of claim 8, wherein program code instructions for receiving the information further include instructions for receiving patient specific and care plan item specific information for a plurality of different patients and wherein program code instructions for storing the information include instructions for storing the patient specific and care plan item specific information received in association with a corresponding care plan item of each respective different patient.

11. The computer program product of claim 8, wherein program code instructions for providing delivery of the portion of the information include instructions for providing a different view of different selected information for respective ones of a patient, a care provider or a care manager.

12. The computer program product of claim 11, wherein program code instructions for providing the different view include instructions for utilizing a view selection algorithm to select view parameters based on the identity.

13. The computer program product of claim 11, wherein program code instructions for providing the different view include instructions for utilizing a view template to provide a view of the selected information based on the identity.

14. An apparatus for providing a distributed care plan manager comprising processing circuitry configured to:
receive, at a service platform, information associated with a care plan item for a patient, the information being received from a health system entity among a plurality of health system entities with which the service platform is capable of communicating;
store the information in association with a care plan of the patient; and
provide delivery of at least a portion of the information to a different entity with selected view parameters for rendering the portion of the information being determined based on an identity of the different entity.

15. The apparatus of claim 14, wherein the processing circuitry is configured to receive the information including receiving additional information from multiple respective ones of the plurality of health system entities and wherein the processing circuitry is configured to store the information by storing the additional information received from each of the multiple respective ones of the plurality of health system entities in association with a corresponding care plan item of the care plan.

16. The apparatus of claim 14, wherein the processing circuitry is configured to receive the information by receiving patient specific and care plan item specific information for a plurality of different patients and wherein the processing circuitry is configured to store the information by storing the patient specific and care plan item specific information received in association with a corresponding care plan item of each respective different patient.

17. The apparatus of claim 14, wherein the processing circuitry is configured to provide delivery of the portion of the information by providing a different view of different selected information for respective ones of a patient, a care provider or a care manager.

18. The apparatus of claim 16, wherein the processing circuitry is configured to provide the different view by utilizing a view selection algorithm to select view parameters based on the identity.

19. The apparatus of claim 16, wherein the processing circuitry is configured to provide the different view by utilizing a view template to provide a view of the selected information based on the identity.

20. The apparatus of claim 14, wherein the processing circuitry is configured to receive the information by receiving the information from health care entities employing different applications for generation of the information.
